(19) United States
(12) Patent Application Publication
(10) Pub. No.: US 2021/0227718 A1
(43) Pub. Date: Jul. 22, 2021

(54) HEAT DISSIPATION FAN OF ELECTRONIC DEVICE

(71) Applicant: CHAMP TECH OPTICAL (FOSHAN) CORPORATION, Foshan (CN)

(72) Inventors: XIAO-GUANG MA, Foshan (CN); YUNG-PING LIN, New Taipei (TW)

(21) Appl. No.: 16/822,133

(22) Filed: Mar. 18, 2020

(30) Foreign Application Priority Data
Jan. 16, 2020 (CN) 202010046095.6

(51) Int. Cl. H05K 7/20; H02K 7/14; F04D 19/00; F04D 25/06; F04D 29/58

(52) U.S. Cl. CPC H05K 7/20136; H02K 7/14; F04D 19/002; F05B 2240/14; F04D 29/582; F05B 2260/2241; F04D 25/0613

(57) ABSTRACT

A fan includes a fan frame, a stator fixedly mounted in the fan frame, and a rotor fixedly mounted in the fan frame. The rotor includes an impeller. The impeller includes a main body and a number of blades equally spaced around a periphery of the main body. The main body includes a top portion and a side portion. The top portion has an annular shape. The side portion has a cylindrical shape and extends from a peripheral edge of the top portion. A number of heat dissipating portions protrudes from an inner side of the top portion. The heat dissipating portions are arranged at intervals.

### FIELD

The subject matter herein generally relates to fans, and more particularly to a fan for dissipating heat generated during operation of the fan.

### BACKGROUND

Generally, electronic devices require a fan to dissipate heat generated by electronic components of the electronic device during operation. However, as size requirements of fans become smaller and smaller, electronic components require increased heat dissipation performance of the fans, so that the fans themselves generate heat during operation. Thus, an improved fan design to dissipate heat generated by the fans is desired.

### BRIEF DESCRIPTION OF THE DRAWINGS

Implementations of the present disclosure will now be described, by way of embodiments, with reference to the attached figures.

FIG. 1 is a cross-sectional view of an embodiment of a fan.

FIG. 2 is a diagram of an impeller of the fan in FIG. 1.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

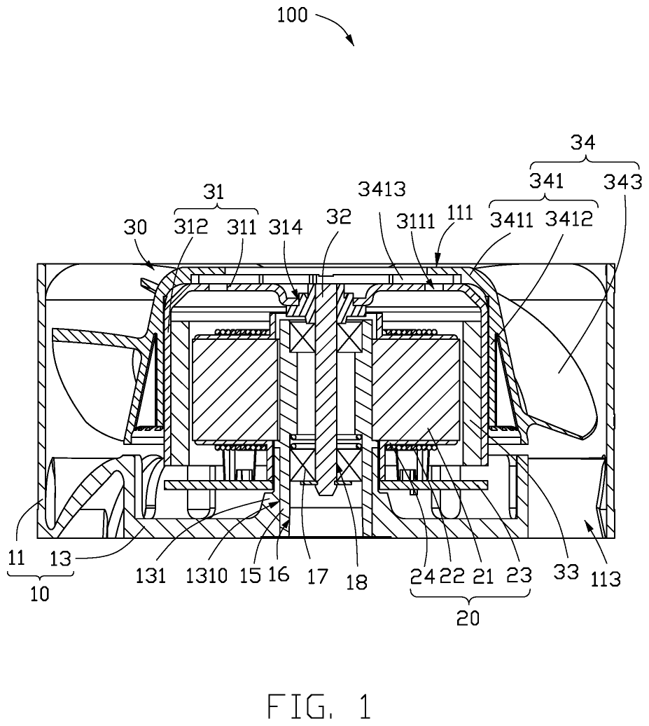

FIG. 1 shows an embodiment of a fan 100. The fan 100 includes a fan frame 10, a stator 20, and a rotor 30. The stator 20 and the rotor 30 are housed in the fan frame 10.

The fan frame 10 includes a hollow frame body 11 and a base 13. In FIG. 1, the base 13 is located at a bottom center of the frame body 11. An air inlet 111 is defined in a top portion of the frame body 11, and an air outlet 113 is defined in a bottom portion of the frame body 11 opposite to the air inlet 111. The base 13 is located at a substantially central portion of the air outlet 113. A hollow post 131 protrudes from a center of an upper surface of the base 13 toward the air inlet 111. A through hole 1310 is defined in a center of the hollow post 131 along an axial direction of the hollow post 131. The fan frame 10 further includes a shaft 15. One end of the shaft 15 is received and fixed in the through hole 1310. The shaft 15 defines a receiving hole 16 along an axial direction of the shaft 15. A bearing 17 is fixedly received in the receiving hole 16 and defines a shaft hole 18 along an axial direction of the bearing 17.

The stator 20 includes a stator core 21, a coil 22, a circuit board 23, and an insulation frame 24. The insulation frame 24 is covered on an outer side of the stator core 21. The coil 22 is wound around the insulation frame 24. The circuit board 23 is located on a bottom of the insulation frame 24 and is electrically connected to the coil 22. The insulation frame 24 is sleeved outside the shaft 15. The insulation frame 24 may be made of an insulating material such as plastic.

The rotor 30 includes a hub 31, a rotation shaft 32, a magnetic group 33, and an impeller 34. The rotation shaft 32 and the magnetic group 33 are located in the hub 31. The magnetic group 33 is wound around the stator 20. The impeller 34 is covered on the hub 31.

The hub 31 includes a substantially circular top wall 311 and a substantially cylindrical side wall 312 extending from a peripheral edge of the top wall 311. A mounting hole 314 is defined in a central portion of the top wall 311. One end of the rotation shaft 32 is mounted in the mounting hole 314, and another end of the rotation shaft 32 is mounted in the shaft hole 18. The magnetic group 33 is located on an inner surface of the sidewall 312 of the hub 31. In one embodiment, the magnetic group 33 has an annular shape.

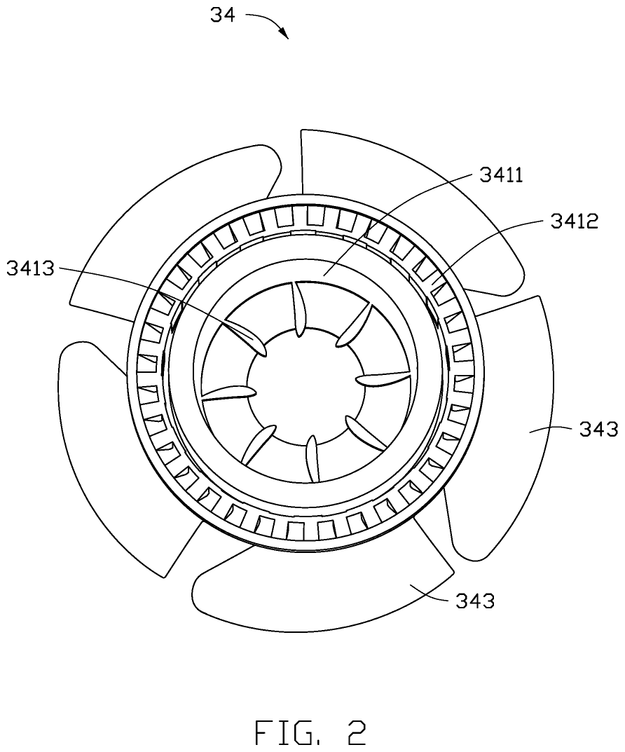

Referring to FIG. 1 and FIG. 2, the impeller 34 includes a main body 341 and a plurality of blades 343. The plurality of blades 343 is arranged around a periphery of the main body 341 and extends radially outward. The main body 341 includes a top portion 3411 and a side portion 3412. The top portion 3411 has a substantially hollow annular shape and faces the top wall 311. The side portion 3412 has a substantially cylindrical shape, extends from a peripheral edge of the top portion 3411, and faces the side wall 312. A plurality of heat dissipating portions 3413 protrudes from an inner side (a side facing the top wall 311) of the top portion 3411. The plurality of heat dissipating portions 3413 is arranged at intervals to form a plurality of heat dissipating spaces therebetween, so that heat generated by components of the fan 100, such as the circuit board 23, is discharged, thereby extending a life of the fan 100 and increasing reliability of the fan 100.

In one embodiment, the heat dissipating portions 3413 extend from a position adjacent to the side portion 3412 in a direction away from the side portion 3412 toward a hollow portion of the top portion 3411.

In one embodiment, each of the heat dissipating portions 3413 has a cross section of an airfoil, that is, one side of the heat dissipating portion 3413 is a flat surface, and another side is a curved surface to achieve a pressure difference between the two sides of the heat dissipating portion 3413. It can be understood that a shape of the heat exhaust portions 3413 can be adjusted according to actual needs. In another embodiment, both sides of the heat dissipating portion 3413 may be curved surfaces.

In one embodiment, the plurality of heat dissipating portions 3413 is arranged at equal intervals. In another embodiment, the plurality of heat dissipating portions 3413 may be arranged at uneven intervals according to actual needs.

In one embodiment, a number of the heat dissipating portions 3413 is eight, but is not limited thereto. In other embodiments, the number of the heat dissipating portions 3413 can be set according to actual needs.

Further, an opening 3111 is defined in the top wall 311 of the hub 31. The opening 3111 faces the plurality of heat dissipating portions 3413, so that the heat of the fan 100 is better transferred to the heat dissipating spaces through the opening 3111.

The fan 100 may be applied in an electronic device (not shown). The electronic device may be a server, a power supply, a charging station, a computer host, a notebook computer, a game console, or the like. The fan 100 dissipates heat for the electronic device. At the same time, heat generated by the fan 100 is dissipated through the heat dissipating portions 3413 on the impeller 34 to extend the life of the fan 100.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A fan comprising:
a fan frame;
a stator fixedly mounted in the fan frame; and
a rotor fixedly mounted in the fan frame, the rotor comprising an impeller; wherein:
the impeller comprises a main body and a plurality of blades equally spaced around a periphery of the main body;
the main body comprises a top portion and a side portion;
the top portion has an annular shape;
the side portion has a cylindrical shape and extends from a peripheral edge of the top portion;
a plurality of heat dissipating portions protrudes from an inner side of the top portion;
the plurality of heat dissipating portions is arranged at intervals.

2. The fan of claim 1, wherein:
the heat dissipating portions extend from a position adjacent to the side portion in a direction away from the side portion toward a hollow portion of the top portion.

3. The fan of claim 2, wherein:
the plurality of heat dissipating portions is arranged at equal intervals.

4. The fan of claim 1, wherein:
one side of the heat dissipating portion is a flat surface, and another side is a curved surface.

5. The fan of claim 1, wherein:
the fan frame comprises a base and a shaft;
a hollow post protrudes from a surface of the base;
a through hole is defined in the hollow post along an axial direction of the hollow post; and
the shaft is received in the through hole.

6. The fan of claim 5, wherein:
the stator comprises a stator core, a coil, a circuit board, and an insulation frame;
the insulation frame is covered on an outer side of the stator core;
the coil is wound around the insulation frame;
the circuit board is located on a side of the insulation frame and is electrically coupled to the coil; and
the insulation frame is sleeved outside the shaft.

7. The fan of claim 6, wherein:
the rotor comprises a hub;
the hub comprises a top wall and a side wall extending from a peripheral edge of the top wall;
the top wall is arranged facing the top portion, and the side wall is arranged facing the side portion; and
the top wall defines an opening facing the plurality of heat dissipating portions.

8. The fan of claim 7, wherein:
the rotor further comprises a rotation shaft;
the shaft defines a receiving hole along an axial direction of the shaft;
a bearing is fixedly received in the receiving hole;
the bearing defines a shaft hole along an axial direction of the bearing;
a mounting hole is defined in a central portion of the top wall;
one end of the rotation shaft is mounted in the mounting hole, and another end of the rotation shaft is mounted in the shaft hole.

9. The fan of claim 8, wherein:
the rotor further comprises a magnetic group;
the magnetic group is located in the hub and is wound around the stator.

10. A fan applicable in an electronic device, the fan comprising:
a fan frame;
a stator fixedly mounted in the fan frame; and
a rotor fixedly mounted in the fan frame, the rotor comprising a hub, a rotation shaft, a magnetic group, and an impeller, the rotation shaft and the magnetic group located in the hub, the magnetic group wound around the stator, and the impeller covered on the hub; wherein:
the impeller comprises a main body and a plurality of blades equally spaced around a periphery of the main body; and
the main body comprises a plurality of heat dissipating portions arranged at intervals on an inner side of the main body.

11. The fan of claim 10, wherein:
the main body comprises a top portion and a side portion;
the top portion has an annular shape;
the side portion has a cylindrical shape and extends from a peripheral edge of the top portion; and
the plurality of heat dissipating portions protrudes from an inner side of the top portion.

12. The fan of claim 11, wherein:
the heat dissipating portions extend from a position adjacent to the side portion in a direction away from the side portion toward a hollow portion of the top portion.

13. The fan of claim 12, wherein:
the fan frame comprises a frame body and a base;
the frame body is hollow;
an air inlet is defined in a first portion of the frame body, and an air outlet is defined in a second portion of the frame body opposite to the air inlet;
the base is located at a central portion of the air outlet; and
a hollow post protrudes from a center of a surface of the base toward the air inlet.

14. The fan of claim 13, wherein:
a through hole is defined in a center of the hollow post along an axial direction of the hollow post;
the fan frame further comprises a shaft;
one end of the shaft is received and fixed in the through hole;
the shaft defines a receiving hole along an axial direction of the shaft;
a bearing is fixedly received in the receiving hole and defines a shaft hole along an axial direction of the bearing.

15. The fan of claim 14, wherein:
the stator comprises a stator core, a coil, a circuit board, and an insulation frame;
the insulation frame is covered on an outer side of the stator core;
the coil is wound around the insulation frame;
the circuit board is located on a side of the insulation frame and is electrically coupled to the coil; and
the insulation frame is sleeved outside the shaft.

16. The fan of claim 15, wherein:
the hub comprises a top wall and a side wall extending from a peripheral edge of the top wall;
the top wall is arranged facing the top portion, and the side wall is arranged facing the side portion; and
the top wall defines an opening facing the plurality of heat dissipating portions.

17. The fan of claim 16, wherein:
a mounting hole is defined in a central portion of the top wall;
one end of the rotation shaft is mounted in the mounting hole, and another end of the rotation shaft is mounted in the shaft hole.
